(19) United States
(12) Patent Application Publication
(10) Pub. No.: US 2003/0169759 A1
(43) Pub. Date: Sep. 11, 2003

(54) Communication device for processing data received from network

(75) Inventor: Takashi Asai, Hyogo (JP)

Correspondence Address: McDERMOTT, WILL & EMERY, 600 13th Street, N.W., Washington, DC, 20005-3096, US

(73) Assignee: MITSUBISHI DENKI KABUSHIKI KAISHA

(21) Appl. No.: 10/323,977

(22) Filed: Dec. 20, 2002

(30) Foreign Application Priority Data
Mar. 7, 2002 (JP) 2002-061841(P)

(51) Int. Cl. H04L 12/54

(52) U.S. Cl. 370/429; 370/395.52

(57) ABSTRACT

A PDA includes: an Ethernet controller which controls transmission and reception of data for a network; a buffer of a communication driver and a receiving window which store the received data; a circuit which transfers the data stored in the buffer of the driver to a designated buffer in response to a request to store the data in the designated buffer, the request issued before preset time passes since the data has been stored in the buffer of the communication driver; a circuit which transfers the data stored in the buffer of the driver to the receiving window when the preset time passes since the data has been stored in the buffer of the driver; and a circuit which transfers the data stored in the receiving window to the designated buffer in response to the request to store the data in the designated buffer.

### BACKGROUND OF THE INVENTION

1. Field of the Invention

The present invention relates to a network communication technique, and particularly to a technique for increasing a communication processing rate if data is received from a network using TCP/IP (Transmission Control Protocol/Internet Protocol).

2. Description of the Background Art

TCP/IP protocol is widely used in data communication executed on the Internet. In recent years, many types of mobile terminals having an Internet browser function exist. The TCP/IP protocol is used for equipment installed to these mobile terminals. Generally, there is a limit to the processing capability and power consumption of a CPU (Central Processing Unit) of such an installed equipment. It is, therefore, necessary to reduce a processing quantity and power consumption required for the TCP/IP protocol.

Ordinary processings in a case where an Ethernet frame including TCP/IP packets is received on the network using the TCP/IP protocol will now be described. A communication equipment which receives the Ethernet frame is notified by a network controller that a network driver received the Ethernet frame. The network driver reads the received Ethernet frame from the network controller and transfers the read frame to the buffer of the network driver. A TCP/IP protocol processing section sequentially analyzes the Ethernet frame, an IP datagram included in the Ethernet frame and a TCP segment included in the IP datagram. The TCP/IP protocol processing section extracts a data part in the TCP segment and transfers the extracted data part to a receiving window. If receiving data according to the TCP protocol, this receiving window is a receiving buffer which is necessary to TCP specifications.

Under the regulations of the TCP protocol, if a TCP/IP data packet is transmitted to the other equipment on the network, it is necessary to include the empty size of the receiving window in a TCP header. Data is held in the receiving window until a data receiving request according to TCP protocol is issued from an application task. When a data receiving request according to the TCP protocol is issued from the application task, data is transferred from the receiving window to a buffer designated by the application task.

As can be seen, according to the ordinary TCP/IP protocol, the data received from the other equipment on the network is transferred from the buffer of the network driver through the receiving window to the buffer designated by the application task. Under the regulations of the TCP/IP protocol, a transmission end communication equipment transmits data in accordance with the empty size of the receiving window notified from the receiving end communication equipment. The receiving end communication equipment is prohibited to decrease the receiving window size halfway along the communication. For this reason, a memory area with a fixed length or a memory area the size of which is not decreased halfway along the communication is normally set in the receiving window so as to realize the TCP/IP protocol.

However, in the processing performed by the receiving end communication equipment, the received data is temporarily transferred to the receiving window and then transferred to the buffer designated by the application task. As a result, the number of times of data transfer increases. Due to this, load on the CPU and hardware necessary for the TCP/IP protocol processing increases to thereby disadvantageously increase power consumption, and it is difficult to secure an empty size in the receiving window of the receiving end communication equipment to thereby disadvantageously decrease data communication rate.

### SUMMARY OF THE INVENTION

It is an object of the present invention to provide a communication device and a mobile terminal capable of decreasing the number of times of data transfer between buffers if data is received from a network according to a protocol specified by TCP/IP or the like.

It is another object of the present invention to provide a communication device and a mobile terminal capable of transferring data with low power consumption if the data is received from a network.

It is yet another object of the present invention to provide a communication device and a mobile terminal capable of executing a data receiving processing at high rate if data is received from a network.

It is still another object of the present invention to provide a communication device and a mobile terminal capable of executing a data receiving processing to correspond to a buffer specification if data is received from a network.

A communication device according to the present invention includes: a network control circuit controlling transmission and reception of a data item for a network; a first storage circuit connected to the network control circuit, and temporarily storing the received data item; a second storage circuit connected to the first storage circuit, and storing the received data item; and a control circuit controlling the data item stored in the first storage circuit and the second storage circuit to be transferred to a predetermined buffer. The control circuit includes: a first transfer control circuit controlling the first storage circuit to transfer the data item stored in the first storage circuit to the buffer in response to a request to store data in the buffer, the request issued before preset time passes since the data item has been stored in the first storage circuit; and a second transfer control circuit controlling the second storage circuit to transfer the data item stored in the first storage circuit to the second storage circuit when the preset time passes since the data item has been stored in the first storage circuit, and to transfer the data item stored in the second storage circuit to the buffer in response to the request to store data in the buffer.

If network communication is held according to, for example, the TCP/IP protocol, the communication device has the buffer of a communication driver serving as the first storage circuit and a receiving window serving as the second storage circuit. If the network control circuit detects the reception of a data item, the data item is stored in the buffer of the communication driver. If a data receiving request is issued from an application task before preset time passes since the data item has been stored in the buffer of the communication driver, the data item stored in the communication driver is transferred to a buffer designated by the application task. In this case, the received data item does not go through the receiving window. On the other hand, when the preset time passes since the data item has been stored in the buffer of the communication driver, the data item stored in the buffer of the communication driver is transferred to the receiving window. Thereafter, when the data receiving request is issued from the application task, the data item stored in the receiving window is transferred to the buffer designated by the application task. In this case, the received data item goes through the receiving window. By doing so, all the received data items are not transferred from the buffer of the communication driver to the receiving window but only the data items for which no receiving request is issued from the application task before the preset time passes are transferred from the buffer of the communication driver to the receiving window. As a result, it is possible to provide a communication device capable of decreasing the number of times of data transfer between the buffers and executing a data receiving processing at high rate with low power consumption if data is received. It is noted that the empty size of the receiving window serving as the second storage circuit is decreased in accordance with the size of the received data items stored in the receiving window. In addition, the empty size of the receiving window is increased in accordance with the size of data items read from the receiving window by the application task. The empty size of this receiving window is transmitted to the other device on the network. The communication device according to the first aspect stores the data to be stored in the receiving window which serves as the second storage circuit, in the buffer of the network driver which serves as the first storage circuit. The empty size of the receiving window transmitted to the other device on the network is calculated for not only the data stored in the receiving window but also the data stored in the network driver (i.e., calculated to include not only the empty size of the receiving window but also the empty size of the buffer of the network driver). In other words, the empty size of the receiving window transmitted to the other device on the network is a size obtained by subtracting the size of the data stored in the receiving window and the size of the data stored in the network driver from the size of the receiving window. In addition, the empty size of the receiving window transmitted to the other device on the network is not a size obtained by adding the empty size of the receiving window and the empty size of the buffer of the network driver. If so, the empty size of the receiving window transmitted to the other device on the network becomes equal to the empty size of the receiving window of a conventional device. Therefore, the communication device according to the present invention does not contradict the TCP/IP protocol specification.

It is more preferable that the first control circuit includes a circuit transferring the data item stored in the first storage circuit to the buffer in response to the request to store the data in the buffer, the request issued before the preset time passes since the data item has been stored in the first storage circuit, until a preset number of data items have been stored in the first storage circuit. The second control circuit includes a circuit transferring the data item stored in the first storage circuit to the second storage circuit if one of a condition that preset time passes since the data item has been stored in the first storage circuit and a condition that the preset number of data items have been stored in the first storage circuit is satisfied, and transferring the data item stored in the second storage circuit to the buffer in response to the request to store the data in the buffer.

If one of the two conditions, i.e., the condition that the preset time passes since the data item has been stored in the buffer of the communication driver and the condition that the preset number of data items have been stored in the buffer of the communication driver, is satisfied, the data item is transferred from the communication driver to the receiving window. As a result, the data item for which no receiving request is issued from the application task before the preset time passes is transferred from the communication driver to the receiving window. In this case, even before the preset time passes, if the preset number of data items are stored in the buffer of the communication driver, the data items exceeding the preset number are transferred from the buffer of the communication driver to the receiving window. As a result, the buffer of the communication driver always stores only data items not greater than the preset number, making it possible to secure a constant size of an empty area. Consequently, it is possible to decrease the probability that data cannot be transmitted to the buffer of the communication driver because of lack of the empty buffer of the communication driver.

It is further preferable that the first transfer control circuit includes a circuit transferring the data item stored in the first storage circuit to the buffer in response to a request to store data in the buffer, the storage request issued before preset time passes since the data item has been stored in the first storage circuit, until a preset capacity of data items have been stored in the first storage circuit. The second transfer control circuit includes a circuit transferring the data item stored in the first storage circuit to the second storage circuit if one of a condition that the preset time passes since the data item has been stored in the first storage circuit and a condition that the preset capacity of data items have been stored in the first storage circuit is satisfied, and transferring the data item stored in the second storage circuit to the buffer in response to the request to store the data in the buffer.

If one of the two conditions, i.e., the condition that the preset time passes since the data item has been stored in the buffer of the communication driver and the condition that the preset capacity of data items have been stored in the buffer of the communication driver, is satisfied, the data item is transferred from the communication driver to the receiving window. As a result, the data item for which no receiving request is issued from the application task before the preset time passes is transferred from the buffer of the communication driver to the receiving window. In this case, even before the preset time passes, if the preset capacity of data items are stored in the buffer of the communication driver, the data items exceeding the preset capacity are transferred from the buffer of the communication driver to the receiving window. As a result, the buffer of the communication driver always stores only data items not greater than the preset capacity, thereby making it possible to secure a constant size of an empty area. Consequently, it is possible to decrease the instance that data cannot be transmitted to the buffer of the communication driver because of lack of the empty buffer of the communication driver.

It is also preferable that the preset time is set based on a communication state of the network.

The preset time can be set based on the communication state of the network. For example, the communication device measures transmission time required for transmitting a data item from the transmission end to the receiving end. If this transmission time is relatively long, time required for the data item to reach the receiving end from the transmission end becomes long, as well. Therefore, the preset time may be set long. By doing so, it is possible to decrease the number of times of temporarily transferring the data item stored in the buffer of the driver to the receiving window and then transferring the data item to the buffer of the application task.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a control block diagram of a PDA into which a communication device according to embodiments of the present invention is installed;

FIG. 2 is a block diagram of a program configuration executed by a CPU shown in FIG. 1;

FIG. 3 is a view showing a structure of data received and transmitted by a communication device according to the embodiments of the present invention;

FIGS. 4 and 5 are flowcharts showing processing procedures executed by a communication device according to a first embodiment of the present invention;

FIGS. 6 to 8 are explanatory views for a transfer processing executed by the communication device according to the first embodiment of the present invention;

FIGS. 9 and 10 are flowcharts showing processing procedures executed by a communication device according to a second embodiment of the present invention;

FIGS. 11 to 13 are explanatory views for a transfer processing executed by the communication device according to the second embodiment of the present invention;

FIG. 14 is a flowchart showing processing procedures executed by a communication device according to a third embodiment of the present invention;

FIGS. 15 to 17 are explanatory views for a transfer processing executed by the communication device according to the third embodiment of the present invention;

FIG. 18 is a flowchart showing processing procedures executed by a communication device according to a fifth embodiment of the present invention;

FIGS. 19 and 20 are explanatory views for a transfer processing executed by the communication device according to the fifth embodiment of the present invention;

FIGS. 21 and 22 are flowcharts showing processing procedures executed by a communication device according to a sixth embodiment of the present invention;

FIGS. 23 to 26 are explanatory views for a transfer processing executed by the communication device according to the sixth embodiment of the present invention;

FIGS. 27 and 28 are flowcharts showing processing procedures executed by a communication device according to a seventh embodiment of the present invention;

FIGS. 29 and 30 are flowcharts showing processing procedures executed by a communication device according to an eighth embodiment of the present invention;

FIGS. 31 and 32 are flowcharts showing processing procedures executed by a communication device according to a tenth embodiment of the present invention; and

FIGS. 33 and 34 are flowcharts showing processing procedures executed by a communication device according to an eleventh embodiment of the present invention.

### DESCRIPTION OF THE PREFERRED EMBODIMENTS

Hereinafter, the embodiments of the present invention will be described with reference to the drawings. It is noted that the same components are denoted by the same reference symbols, respectively, in the following description and the drawings. The names and functions thereof are the same. These components will not be, therefore, repeatedly described.

First Embodiment

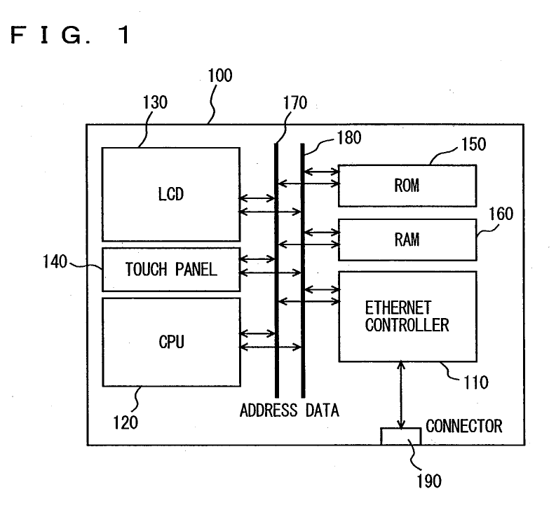

A control block of a PDA (Personal Digital Assistant) into which a communication device according to the first embodiment of the present invention is installed will be described with reference to FIG. 1. As shown in FIG. 1, a PDA 100 includes an Ethernet controller 110 which is an interface with the network and which notifies a CPU 120 of an interrupt signal when data transmission and reception is completed, CPU 120 which controls the entirety of PDA 100, and an LCD (Liquid Crystal Display) 130 and a touch panel 140 which are man-machine interfaces, a ROM (Read Only Memory) 150 and a RAM (Random Access Memory) 160 which store a program for executing a processing to the described later and operation results halfway along the execution of the program. In addition, Ethernet controller 110 is connected to a connector 190 for the connection to the network.

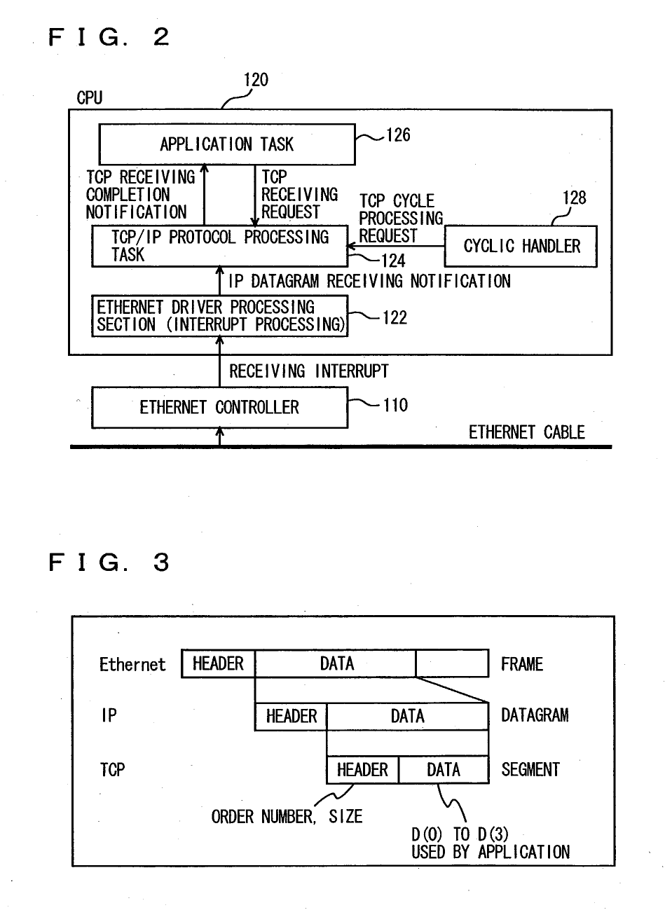

Referring to FIG. 2, a configuration of a program receiving processing executed by the communication device according to this embodiment will be described. When detecting that a frame addressed to its own station is transmitted over an Ethernet cable, Ethernet controller 110 performs receiving processings including an error detect processing to the frame. Thereafter, Ethernet controller 110 notifies an Ethernet driver processing section 122 of the receiving of the Ethernet frame by performing an interrupt processing.

Ethernet driver processing section 122 is started in response to the interrupt signal from Ethernet controller 110 and analyzes the header part of the received Ethernet frame. If an IP datagram is included in the Ethernet frame, Ethernet driver processing section 122 notifies a TCP/IP protocol processing task 124 of the receiving of the IP datagram.

If data according to the TCP/IP protocol is received, an application task 126 notifies a data receiving request to TCP/IP protocol task 124. At this moment, application task 126 also notifies TCP/IP protocol task 124 of information about an address at which the TCP/IP protocol data is stored, the size of the TCP/IP protocol data or the like. Application task 126 is set in a wait state until TCP/IP protocol processing task 124 notifies application task 126 of the completion of receiving.

A cyclic handler 128 is started at preset time intervals and instructs TCP/IP protocol processing task 124 to cyclically execute a communication processing.

TCP/IP protocol processing task 124 executes a TCP/IP protocol processing in response to the notification from application task 126, cyclic handler 128, Ethernet driver processing section 122 or the like.

Referring to FIG. 3, the structure of data processed by the communication device according to the first embodiment will be described. As shown in FIG. 3, the Ethernet frame includes a header and data. The data of the Ethernet frame is referred to as “IP datagram” which includes a header and data. The data of the IP datagram is referred to as “TCP segment” which includes a header and data.

The header of the TCP segment stores order numbers indicating a data transmission order, data size and the like. The data of the TCP segment stores data (e.g., D(0), D(1), D(2) and D(3)) to be used by an application task.

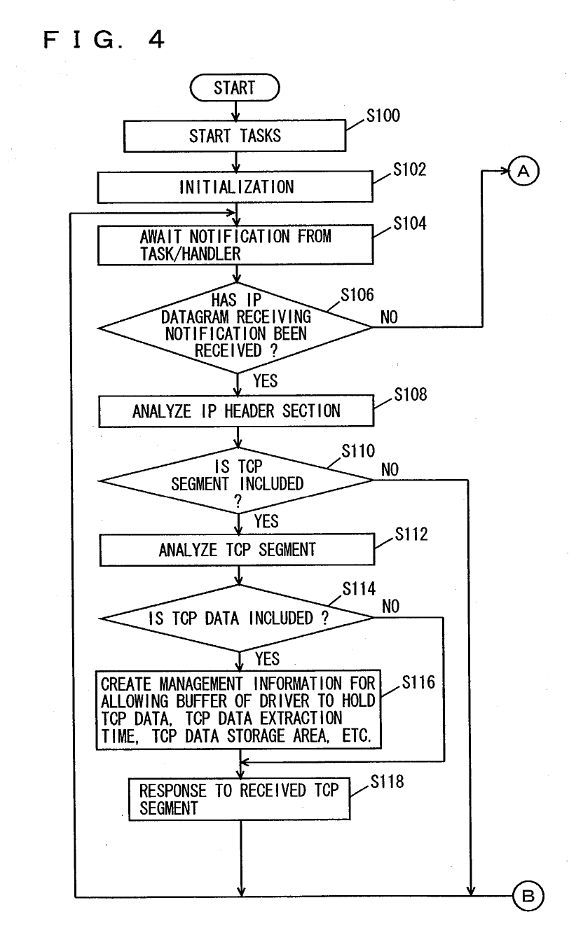

Referring to FIG. 4, the program executed by PDA 100 into which the communication device according to this embodiment is installed has the following control structure.

In step (abbreviated to as “S” hereinafter) 100, CPU 120 starts various tasks. In S102, CPU 120 performs an initialization processing. At this moment, variables and the like are initialized.

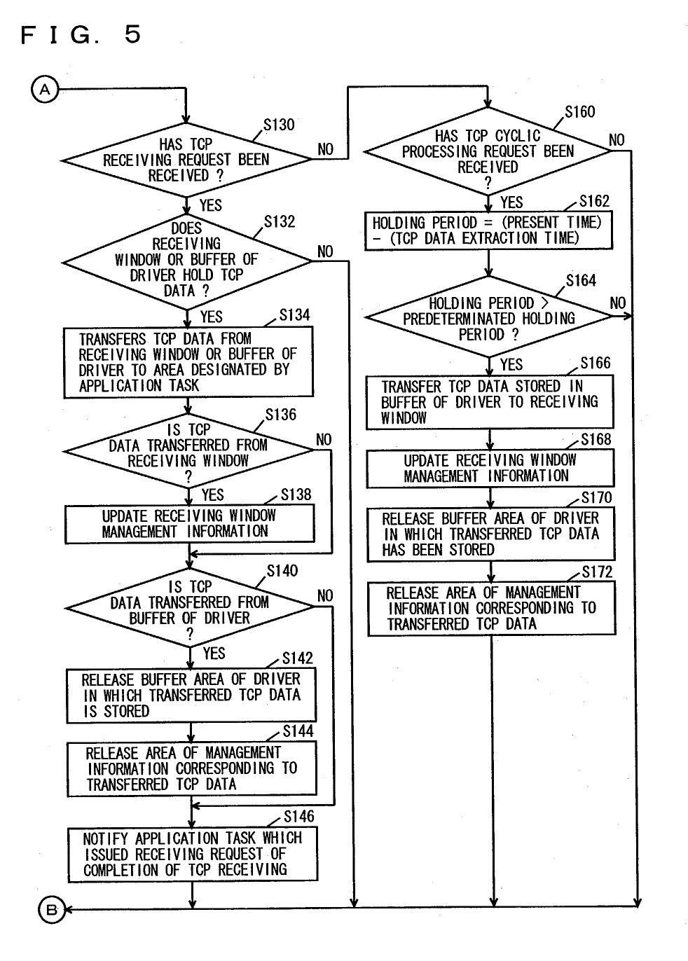

In S104, CPU 120 awaits a notification from a task or a handler. In S106, CPU 120 determines whether or not CPU 120 has received an IP datagram receiving notification. If the IP datagram receiving notification is received (“YES” in S106), processing proceeds to S108. If not (“NO” in S106), the processing proceeds to S130 shown in FIG. 5.

In S108, CPU 120 analyzes an IP header part. In S110, CPU 120 determines whether or not a TCP segment is included. If a TCP segment is included (“YES” in S110), the processing proceeds to S112. If not (“NO” in S110), the processing returns to S104.

In S112, CPU 120 analyzes the TCP segment. In S114, CPU 120 determines whether or not TCP data is included. If TCP data is included (“YES” in S114), the processing proceeds to S116. If not (“NO” in S114), the processing proceeds to S118.

In S116, CPU 120 creates management information for allowing the driver of Ethernet driver processing section 122 to hold the TCP data. The created information includes time at which the TCP data is extracted, a TCP data storage area and the like.

In S118, CPU 120 performs a response processing in response to the received TCP segment. The processing then returns to S104.

Referring to FIG. 5, in S130, CPU 120 determines whether or not a TCP receiving request has been received. If the TCP receiving request has been received (“YES” in S130), the processing proceeds to S132. If not (“NO” in S130), the processing proceeds to S160.

In S132, CPU 120 determines whether or not a receiving window or the buffer of the driver holds the TCP data. If the receiving window or the buffer of the driver has TCP data (“YES” in S132), the processing proceeds to S134. If not (“NO” in S132), the processing returns to S104 in FIG. 4.

In S134, CPU 120 transfers the TCP data from the receiving window or the buffer of the driver to a buffer area designated by the application task.

In S136, CPU 120 determines whether or not the TCP data is transferred from the receiving window. If the TCP data is transferred from the receiving window (“YES” in S136), the processing proceeds to S138. If not (“NO” in S136), the processing proceeds to S140.

In S138, CPU 120 updates receiving window management information. In S140, CPU 120 determines whether or not the TCP data is transferred from the buffer of the driver. If the TCP data is transferred from the buffer of the driver (“YES” in S140), the processing proceeds to S142. If not (“NO” in S140), the processing proceeds to S146.

In S142, CPU 120 releases the buffer area of the driver in which the transferred TCP data is stored. In S144,CPU 120 releases the area of the management information corresponding to the transferred TCP data.

In S146, CPU 120 notifies the application task which issued the receiving request of the completion of TCP receiving. Thereafter, the processing returns to S104 shown in FIG. 4.

In S160, CPU 120 determines whether or not a TCP cyclic processing request has been received. If the TCP cyclic processing request has been received (“YES” in S160), the processing proceeds to S162. If not (“NO” in S160), the processing proceeds to S104 shown in FIG. 4.

In S162, CPU 120 sets holding time as holding time=(present time)−(TCP data extraction time). In S164, CPU 120 determines whether or not the holding time is longer than preset holding time. If the holding time is longer than the preset holding time (“YES” in S164), the processing proceeds to S166. If not (“NO” in S164), the processing proceeds to S104 shown in FIG. 4.

In S166, CPU 120 transfers the TCP data stored in the buffer of the driver to the receiving window. In S168, CPU 120 updates the receiving window management information. In S170, CPU 120 releases the buffer area of the driver in which the transferred TCP data is stored. In S172, CPU 120 releases the area of the management information corresponding to the transferred TCP data. Thereafter, the processing returns to S104 shown in FIG. 4.

The operation of PDA 100 including the communication device according to this embodiment based on the above-mentioned structure and flowcharts will be described.

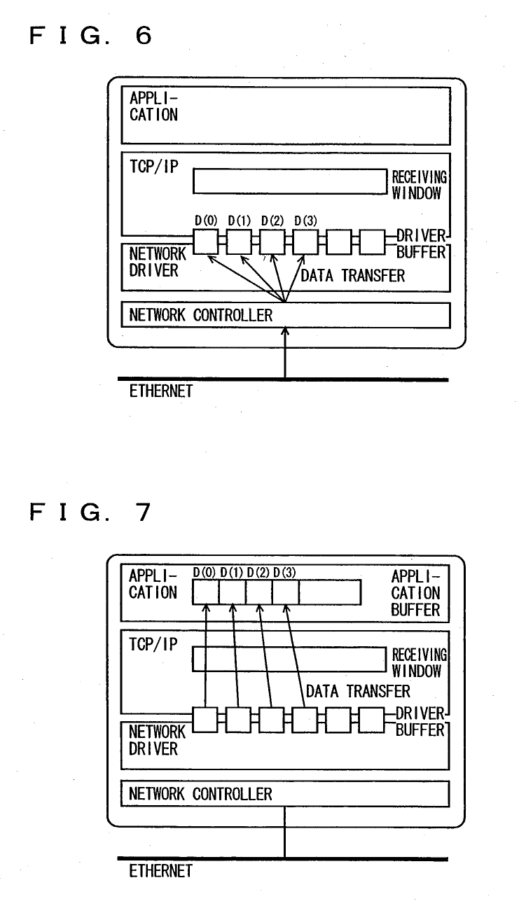

FIGS. 6 to 8 show processing procedures if PDA 100 including the communication device according to this embodiment receives an Ethernet frame including a TCP/IP packet from the Ethernet.

As shown in FIG. 6, Ethernet controller 110 detects a frame having an Ethernet address addressed to its own station from Ethernet frames flowing on the Ethernet (“YES” in S106). Ethernet controller 110 stores the received frame in the memory. Ethernet controller 110 notifies Ethernet driver 122 of the receiving of the frame. Ethernet driver 122 transfers the Ethernet frame received from Ethernet controller 110 to the buffer of the driver. TCP/IP protocol processing task 124 analyzes the Ethernet frame stored in the buffer of the driver, the IP datagram included in the Ethernet frame and header information and data on the TCP segment included in the IP datagram (in S108 and S112), determines whether or not the frame and the like are addressed to its own station, whether or not there is an error in the data and the like, and finally extracts TCP data D(0) (“YES” in S114).

Data D(0) is not transferred to the receiving window. Instead, data D(0) is held in the buffer of the driver. At this moment, information for managing time T(0) at which data D(0) was extracted, memory arrangement address information on data D(0), the size of data D(0) and the like is created (in S116). Likewise, if three other Ethernet frames are received, data D(1) to D(3) is held in the buffer of the driver and management information including time T(1) to T(3) for which data D(1) to D(3) is held and the like is created. It is assumed herein that time for holding each of data D(0) to D(3) in the buffer of the driver is not longer than preset time.

FIG. 7 shows a case where the TCP data receiving request is issued from application task 126 by preset time. If the receiving request is issued from application task 126, the management information corresponding to data D(0) to D(3) held in the buffer of the driver is referred to and data D(0) to D(3) is transferred from the buffer of the driver to a buffer designated by application task 126 (in S134). The management information corresponding to transferred data D(0) to D(3) is erased (in S144).

Here, if the total size of data D(0) to D(3) held in the buffer of the driver is larger than the size of the buffer designated by application task 126, some of data D(0) to D(3) held in the buffer of the driver is transferred by as much as a size equal to that of the buffer designated by application task 126. Only the management information on the data completely transferred is erased and data which is not completely transferred is held in the buffer of the driver (including a case where only a part of the data is transferred) and the management information is updated so as to correspond to the data.

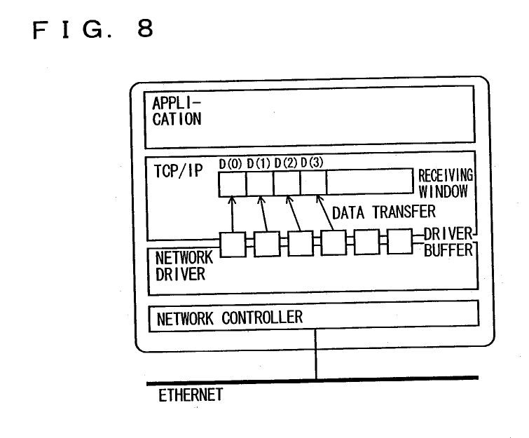

FIG. 8 shows a case were no TCP data receiving request is issued from application task 126 by the preset time. If a receiving request is not issued from application task 126 at certain time T, the management information corresponding to data D(0) to D(3) stored in the buffer of the driver is referred to and periods dT(0) to dT(3) from time T until time T(0) to T(3) for which the respective data is held are calculated (in S162).

If periods dT(O) to dT(3) exceed preset time; data D(0) to D(3) is transferred from the buffer of the driver to the receiving window (in S166) and the management information corresponding to the transferred data is erased (in S172).

As can be seen, in a PDA into which the communication device according to this embodiment is installed, if the receiving request is issued from the application task by the preset time, data is transferred from the buffer of the driver to the buffer designated by the application task without going through the receiving window. Due to this, compared with the conventional art, the number of times of data transfer is decreased. By decreasing the number of times of data transfer, power consumption required for the TCP protocol processing is decreased. In addition, if the receiving request is not issued from the application task with the preset time exceeded, the data held in the driver is transferred to the receiving window. Due to this, compared with a case where no time limitation is given, the probability that the buffer of the driver is occupied by data decreases. As a result, if an Ethernet frame which does not include a packet according to the TCP/IP protocol (such as a packet according to ARP (Address Resolution Protocol), ICMP (Internet Control Message Protocol), UDP/IP (User Datagram Protocol/Internet Protocol or the like), it is possible to decrease the probability that the Ethernet controller cannot transfer the received Ethernet frame even while a plurality of applications are executed and communication with a plurality of equipment are held. Consequently, it is possible to prevent transfer rate at the time of receiving data from being decreased.

In this embodiment, a case where the data according to the TCP protocol included in the Ethernet frame is received has been described. However, the present invention is not limited to this case. For example, even if TCP data included in the other frame, e.g., a PPP (Point-to-Point Protocol) frame is received, the communication device according to this embodiment can be used. A transmission path is not limited to the Ethernet but may be the other transmission path such as a transmission path utilizing a telephone line using a modem.

Second Embodiment

A PDA which includes a communication device according to the second embodiment will be described. The hardware configuration of the PDA according to this embodiment is the same as that of the PDA according to the first embodiment. The detailed description thereof will not be, therefore, repeatedly given herein.

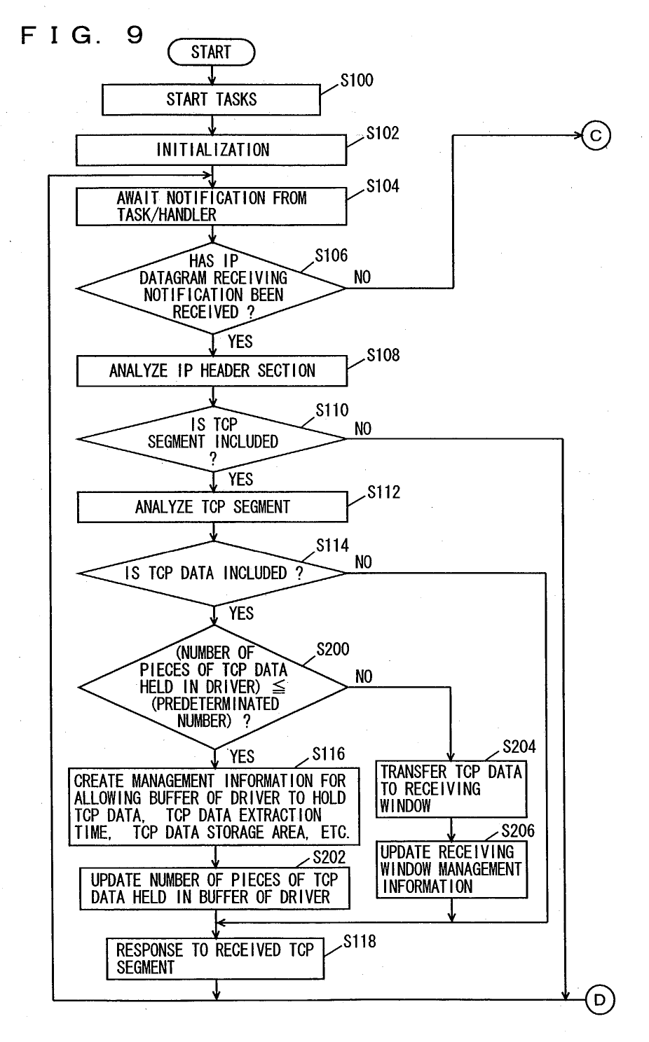

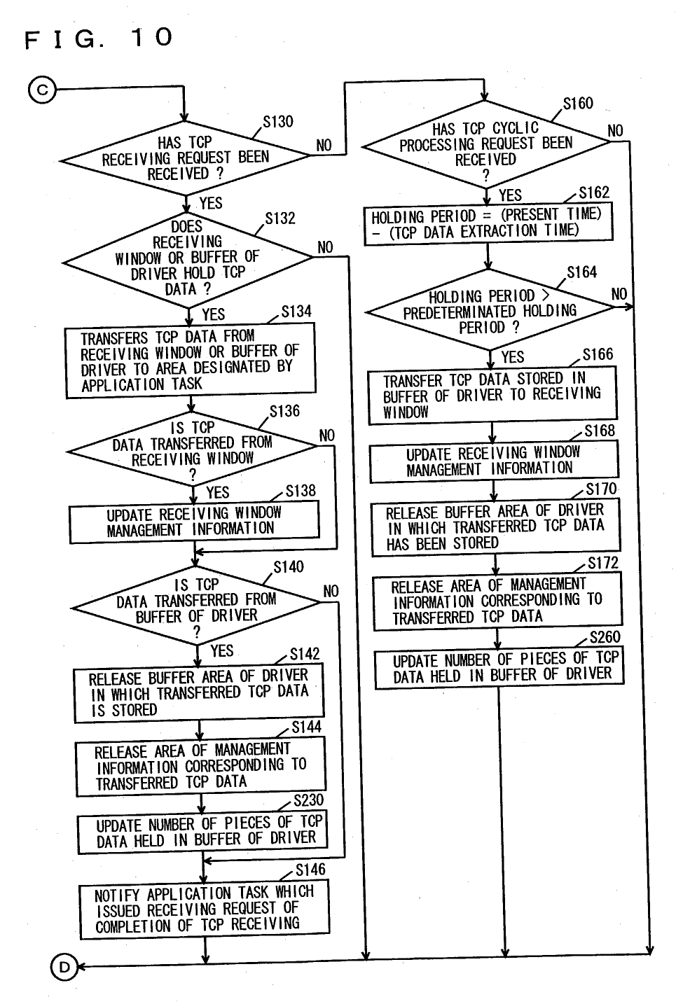

Referring to FIGS. 9 to 10, a program executed by the PDA including the communication device according to this embodiment has the following control structure. In the flowchart shown in FIG. 9, the same processings as those in the flowchart shown in FIG. 4 are denoted by the same step numbers, respectively. In the flowchart shown in FIG. 10, the same processings as those in the flowchart shown in FIG. 5 are denoted by the same step numbers, respectively. These processings will not be, therefore, repeatedly described herein.

In S200, CPU 120 determines whether or not the number of pieces of TCP data held in the driver is not greater than a preset number. If the number of pieces of TCP data held in the driver is not greater than a preset number (“YES” in S200), the processing proceeds to S116. If not (“NO” in S200), the processing proceeds to S204.

In S202, CPU 120 updates the number of pieces of TCP data held in the buffer of the driver.

In S204, CPU 120 transfers the TCP data to the receiving window. In S206, CPU 120 updates management information on the receiving window.

After S202 and S206, the processing proceeds to S118.

Referring to FIG. 10, if a TCP receiving request is received, CPU 120 updates the number of pieces of TCP data held in the buffer of the driver in S230.

If the TCP cyclic processing request is received, CPU 120 updates the number of pieces of TCP data held in the buffer of the driver in S260.

The operation of the PDA which includes the communication device according to this embodiment based on the above-mentioned structure and the flowcharts will be described.

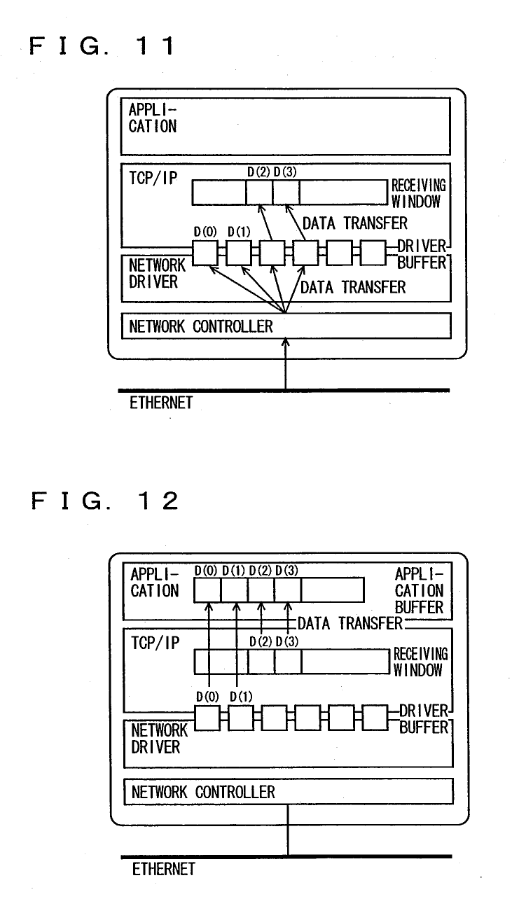

FIGS. 11 to 13 show processing procedures if the PDA according to this embodiment receives an Ethernet frame including TCP/IP packets. In this embodiment, as in the case of the first embodiment, after TCP segment data is extracted, the data is not transferred to the receiving window but held in the buffer of the driver until preset time. The second embodiment, however, differs from the first embodiment in that the number of pieces of data held in the buffer of the driver is limited to not greater than a preset number. Namely, if data exceeding the preset number is received, the received data is not held in the buffer of the driver but transferred to and held in the receiving window.

FIG. 11 shows a case were the preset number of pieces of data is “2”. Data D(0) to D(1) received by the PDA is held in the buffer of the driver until a receiving request is issued from application task 126 before the respective preset data passes as in the case of the first embodiment (“YES” in S200). Data D(2) to D(3) received thereafter is transferred from the buffer of the driver to the receiving window and held in the receiving window. This is because the number of pieces of data exceeds the preset number (“NO” in S200).

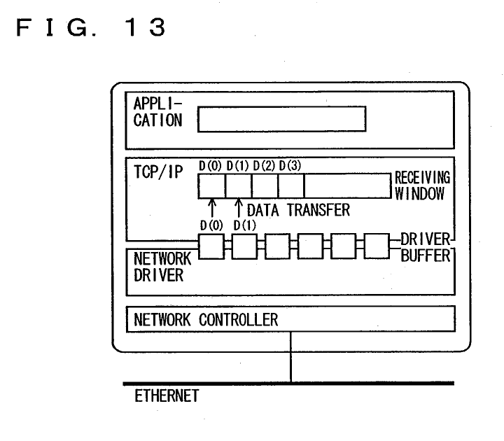

FIG. 12 shows a case where a receiving request is issued from application task 126 after the processing shown in FIG. 11 and if periods for which data D(0) to D(1) is held in the buffer of the driver fall within preset periods, respectively. When a receiving request is issued from application task 126 (“YES” in S130), management information corresponding to data D(0) to D(1) held in the buffer of the driver is referred to and data D(0) to D(1) is transferred from the buffer of the driver to a buffer designated by application task 126 (in S134). The management information corresponding to data D(0) to D(1) transferred from the buffer of the driver is erased (in S144).

It is determined whether or not there is data held in the receiving window (in S132), and data D(2) to D(3) is transferred from the receiving window to the buffer designated by application task 126 (in S134). Here, if the total size of data D(0) to D(3) is larger than the size of the buffer designated by application task 126, some of data D(0) to D(3) is transferred by as much as a size equal to the size of the buffer designated by application task 126 and remaining data is continuously held.

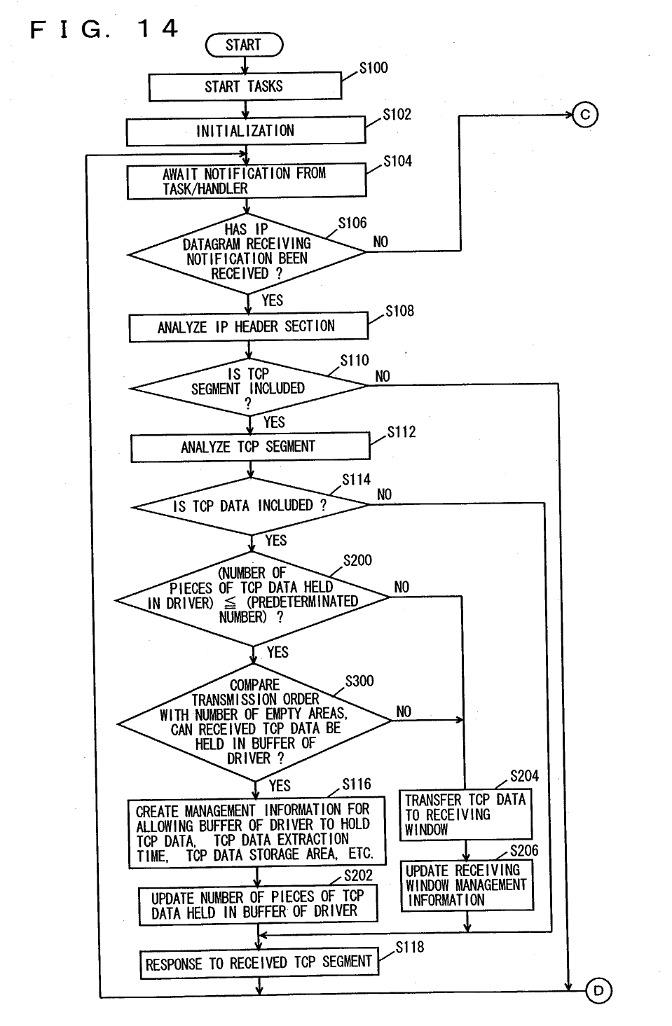

FIG. 13 shows a case where a TCP protocol data receiving request is not issued from application task 126 after the processing shown in FIG. 11 and even if the periods for which data D(0) to D(1) is held in the buffer of the driver exceed a preset period. If no receiving request is issued from application task 126 at certain time T, management information corresponding to data D(0) to D(1) stored in the buffer of the driver is referred to and periods dT(0) to dT(1) from time T until time T(0) to T(1) for which the respective data is held are calculated (in S162). If periods dT(0) to dT(1) exceed the preset time (“YES” in S164), data D(0) to D(1) is transferred from the buffer of the driver to the receiving window (in S166) and the management information corresponding to the respective data is erased (in S172).

As can be seen, in the PDA including the communication device according to this embodiment, if a receiving request is issued from the application task before preset time, data D(0) to D(1) is transferred from the buffer of the driver to the buffer designated by the application task without going through the receiving window. In addition, since the number of pieces of data held in the buffer of the driver is limited to not greater than the preset number, it is possible to secure the empty capacity of the buffer of the driver by as much as the predetermined number of data. Due to this, even if an Ethernet frame which does not include TCP/IP packets is received or even if a plurality of application tasks are executed on the PDA and the respective application tasks communicate with other devices, it is possible to decrease the probability that the Ethernet frame received by the Ethernet controller cannot be transferred to the buffer of the driver.

Third Embodiment

A PDA which includes a communication device according to the third embodiment will be described. The hardware configuration of the PDA according to this embodiment is the same as that of the PDA according to the first embodiment. The detailed description thereof will not be, therefore, repeatedly given herein.

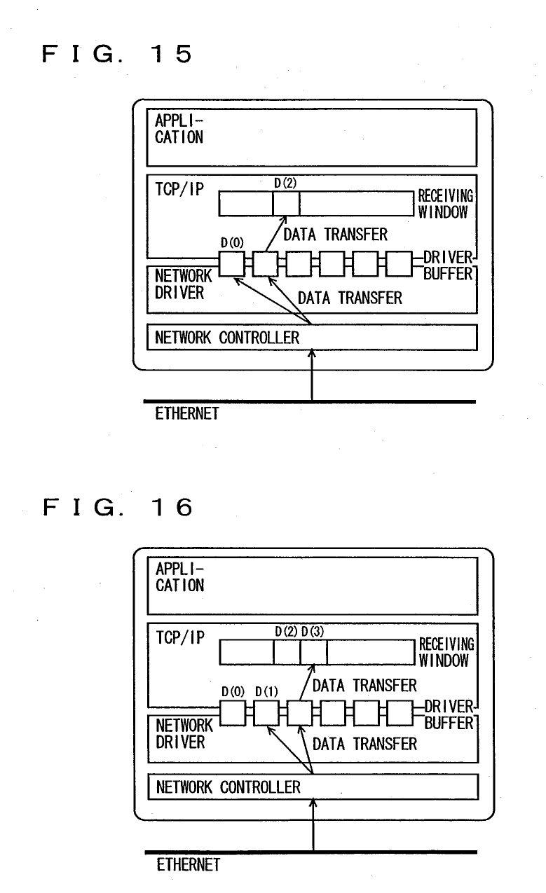

Referring to FIG. 14, a program executed by the PDA including the communication device according to this embodiment has the following control structure. In the flowchart shown in FIG. 14, the same processings as those in the flowchart shown in FIG. 9 are denoted by the same step numbers, respectively. These processings will not be, therefore, repeatedly described herein.

In S300, CPU 120 compares a transmission order with the number of empty areas and determines whether or not the received TCP data can be held in the buffer of the driver. If the comparison between the transmission order and the number of empty areas shows that the TCP data can be held in the buffer of the driver (“YES” in S300), the processing proceeds to 5116. If not (“NO” in S300), the processing proceeds to S204.

After the processing in S116, the processing proceeds to S202 and S118 and then returns to S104.

After the processing in S204, the processing proceeds to S206 and S118 and then returns to S104.

The operation of the PDA which includes the communication device according to this embodiment based on the above-mentioned structure and the flowcharts will be described.

FIGS. 15 to 17 show processings if the PDA including the communication device according to this embodiment receives an Ethernet frame which includes TCP/IP packets from the Ethernet. It is assumed herein that a transmission end communication device transmits the Ethernet frame including data D(0), D(1), D(2), and D(3) in this order and that a receiving end the PDA receives the Ethernet frame including data D(0), D(2), D(1), and D(3) in this order.

In this embodiment, as in the case of the second embodiment, after the data of a TCP segment is extracted, the extracted data is not transferred to the receiving window but held in the buffer of the driver until preset time. Further, it is assumed that the number of pieces of data held in the buffer of the driver is not greater than a preset number. In the second embodiment, the data is held in the buffer of the driver by as much as the preset number of data in the order of receiving by the PDA. In this embodiment, by contrast, only the data in the order of transmission by the transmission end device and within a range of the preset number is held in the buffer of the driver. The other data is transferred from the buffer of the driver to the receiving window.

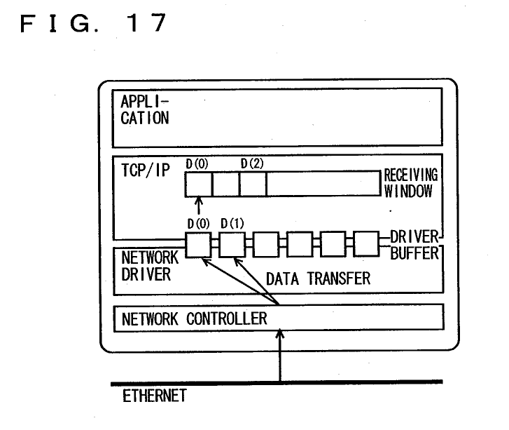

FIGS. 15 to 16 show a case where the preset number of pieces of data is “2”. The transmission communication device transits the Ethernet including data D(0), D(1), D(2) and D(3) in this order. When receiving data D(0) and D(1) (“YES” in S300), the PDA performs processing in accordance with the order of transmission. The PDA holds the data in the buffer of the driver by preset time in accordance with the order of transmission. If other data D(2) and D(3) is received (“NO” in S300), the other data is transferred from the buffer of the driver to the receiving window (in S204).

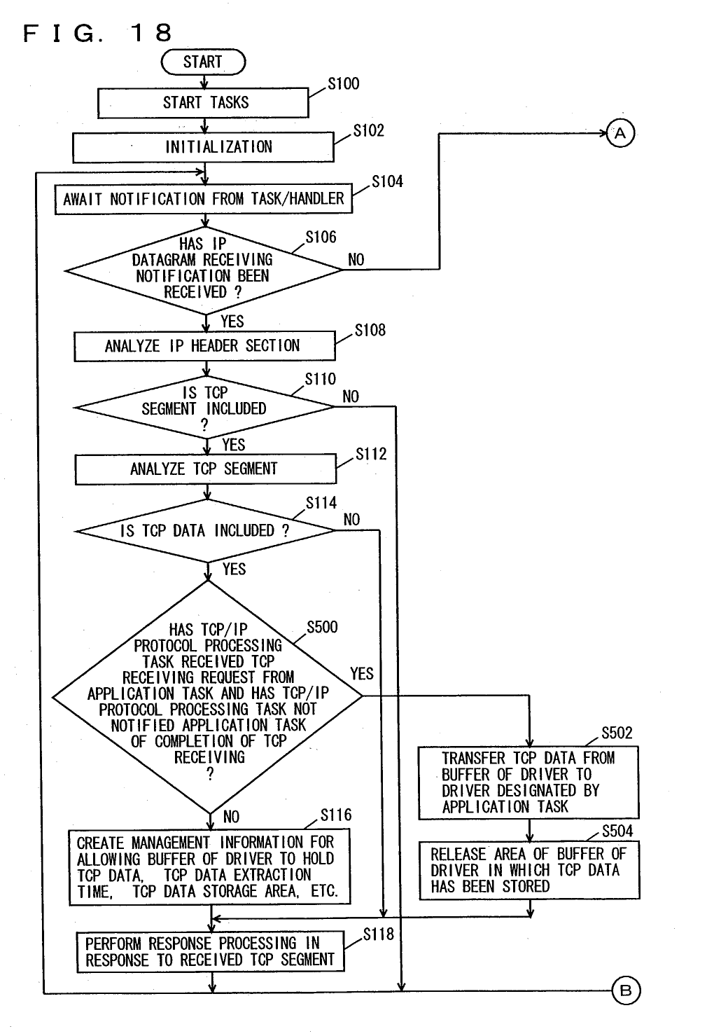

Since there is a limitation that a period for which data is held in the buffer of the driver is within the preset time. Due to this, data D(0) is held in the buffer of the driver for the preset time. However, if no receiving request is issued from application task 126 by the preset time, processing procedures are those shown in FIG. 17. That is, data D(0) is transferred to the receiving window. After the transfer of data D(0), the number of pieces of data held in the buffer of the driver becomes “1”. Due to this, if data D(3) is received, data D(3) is held in the buffer of the driver.

As can be seen, in the PDA including the communication device according to this embodiment, data processing is performed not in the order of receiving but in the order of transmission. Normally, the application task issues a TCP data receiving request in the order of transmission of data from the transmission end communication device. Even in that case, a receiving request is issued for the data transmitted later among the data transmitted from the transmission end communication device, from the application task at the same time as or after the time of the data transmitted previously. Due to this, it is possible to decrease the number of pieces of data transferred to the receiving window after the passage of preset time by limiting the number of pieces of data held in the buffer of the driver to not greater than a preset number based on the order of transmission, compared with a case where data is held based on the order of receiving.

Fourth Embodiment

A PDA which includes a communication device according to the fourth embodiment will be described. The hardware configuration of the PDA according to this embodiment is the same as that of the PDA according to the first embodiment. The detailed description thereof will not be, therefore, repeatedly given herein.

In the second and third embodiments, it is determined whether or not the received data is to be held in the buffer of the driver based on the preset number. In the fourth embodiment, by contrast, the processings of the PDA are performed based on a different rule.

In this embodiment, based on not the preset number but on a preset data size, data is held in the buffer of the driver. That is, if the sum of the total size of data held in the buffer of the driver and the total size of received data is not larger than the preset data size, then the received data is held in the buffer of the driver. If the sum of the total size of data held in the buffer of the driver and the size of received data exceeds the preset data size, then all or part of the received data is transferred to the receiving window.

As can be seen, the PDA including the communication device according to this embodiment performs processings based on the data size instead of the number of pieces of data unlike the second and third embodiments. The other processings are the same as those in the second and third embodiment and will not be, therefore, repeatedly described herein.

As mentioned above, in the PDA including the communication device according to this embodiment, it is determined whether or not data is to be held in the buffer of the driver based on not the number of pieces of received data. Instead, it is determined whether or not data is to be held in the buffer of the driver by comparing the sum of the total size of the data held in the buffer of the driver and the total size of the received data with the preset data size. By doing so, if the size of the received data is relatively small, the number of the empty areas of the buffer of the driver increases compared with a case where the sizes of the respective received data are relatively large. In other word, it is possible to effectively utilize the buffer of the driver by as much as the increase of the empty areas of the buffer of the driver.

Fifth Embodiment

A PDA which includes a communication device according to the fifth embodiment will be described. The hardware configuration of the PDA according to this embodiment is the same as that of the PDA according to the first embodiment. The detailed description thereof will not be, therefore, repeatedly given herein.

Referring to FIG. 18, a program executed by the PDA including the communication device according to this embodiment has the following control structure. In the flowchart shown in FIG. 18, the same processings as those in the flowchart shown in FIG. 4 are denoted by the same step numbers, respectively. These processings will not be, therefore, repeatedly described herein.

In S500, CPU 120 determines whether or not TCP/IP protocol processing task 124 has received a TCP receiving request from application task 126 and has not notified application task 126 of the completion of TCP receiving. That is, CPU 120 determines whether or not a TCP receiving request from application task 126 are waited. If TCP/IP protocol processing task 124 has received a TCP receiving request from application task and has not notified application task 126 of the completion of TCP receiving (“YES” in S500), then the processing proceeds to S502. If not (“NO” in S500), the processing proceeds to S116.

In S502, CPU 120 transfer the TCP data from the buffer of the driver to the buffer area designated by the application task. In S504, CPU 120 releases the area of the buffer of the driver in which the TCP data has been stored. Thereafter, the processing proceeds to S118 and then returns to S104.

After the processing in S116, the processing proceeds to S118 and then returns to S104.

The operation of the PDA which includes the communication device according to this embodiment based on the above-mentioned structure and the flowcharts will be described.

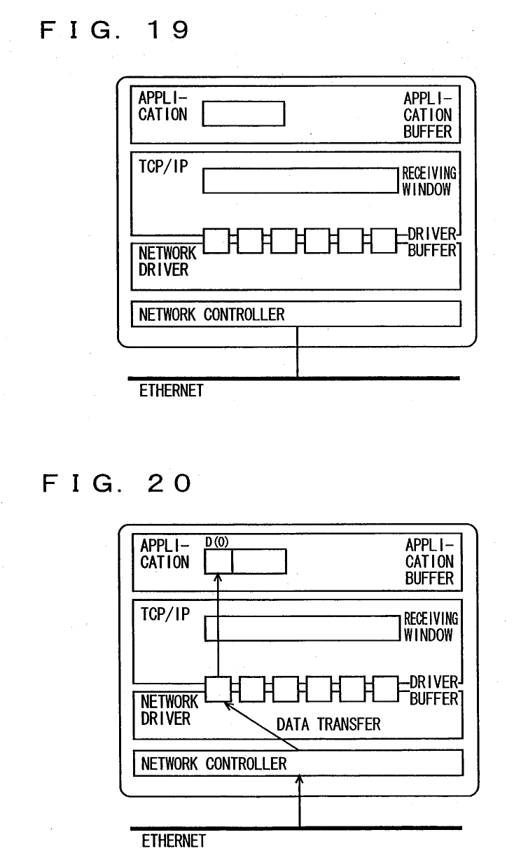

FIGS. 19 to 20 show a case where an Ethernet frame including TCP/IP packets is received if a receiving request from application task 126 of the PDA including the communication device according to this embodiment is in a wait state.

As shown in FIG. 19, when a receiving request is issued from application task 126, no data is held in the receiving window and the buffer of the driver. This indicates that a receiving request issued from application task 126 is in a wait state.

FIG. 20 shows processing if a receiving request from application task 126 is in a wait state (see FIG. 19) and an Ethernet frame including TCP/IP packets is received. As shown in FIG. 20, Ethernet controller 110 detects a frame having an Ethernet address addressed to its own station from Ethernet frames flowing on the Ethernet. Ethernet controller 110 stores the received frame in the memory. Ethernet controller 110 notifies Ethernet driver 122 of the receiving of the frame.

Ethernet driver 122 transfers the frame received from Ethernet controller 110 to the buffer of the driver. TCP/IP protocol processing task 124 analyzes the Ethernet frame stored in the buffer of the driver, the IP datagram included in the Ethernet frame and header information and data on the TCP segment included in the IP datagram, determines whether or not the frame and the like are addressed to its own station, whether or not there is an error in the data and the like, and finally extracts data D(0) of the TCP segment. Thereafter, extracted data D(0) is transferred from the buffer of the driver directly to the buffer designated by application task 126 without going through the receiving window.

As can be seen, in PDA according to this embodiment, even if a receiving request from the application task-is issued before data is received, the data received after the receiving request is transferred from the buffer of the driver to the buffer designated by the application task without going through the receiving window. As a result, compared with the conventional art, it is possible to decrease the number of times of data transfer. Consequently, it is possible to decrease power consumption required for the TCP protocol processing.

Sixth Embodiment

A PDA which includes a communication device according to the sixth embodiment will be described. The hardware configuration of the PDA according to this embodiment is the same as that of the PDA according to the first embodiment. The detailed description thereof will not be, therefore, repeatedly given herein.

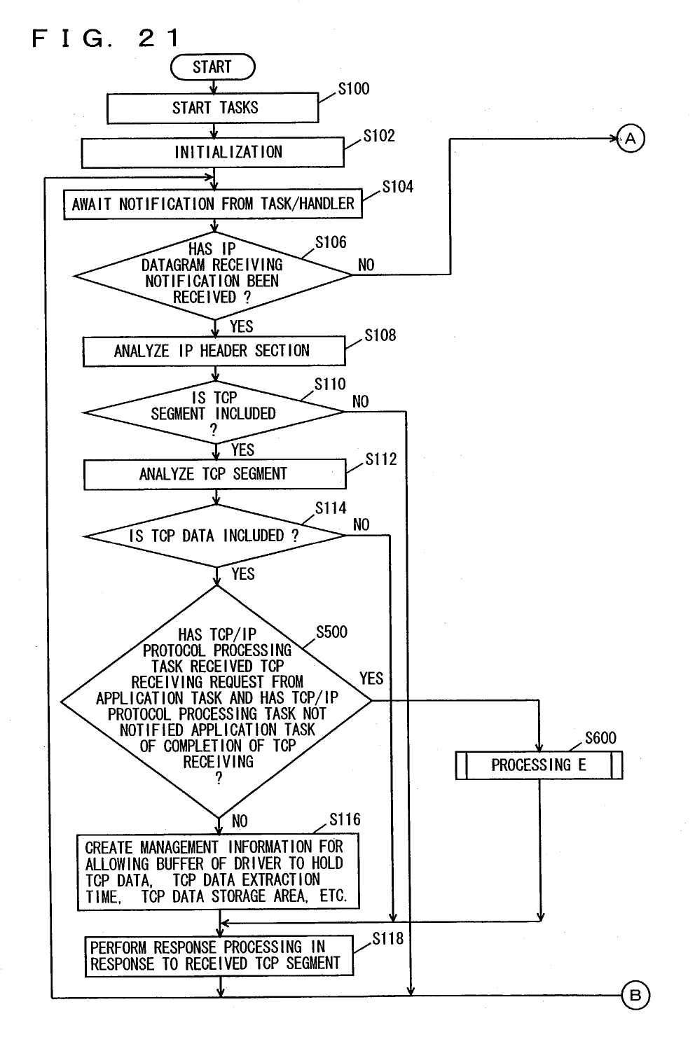

Referring to FIG. 21, a program executed by the PDA including the communication device according to this embodiment has the following control structure. In the flowchart shown in FIG. 21, the same processings as those in the flowchart shown in FIG. 18 are denoted by the same step numbers, respectively. These processings will not be, therefore, repeatedly described herein.

If TCP/IP protocol processing task 124 has received a TCP receiving request from application task 126 and has not notified application task 126 of the completion of TCP receiving, then CPU 120 performs a processing E in S600.

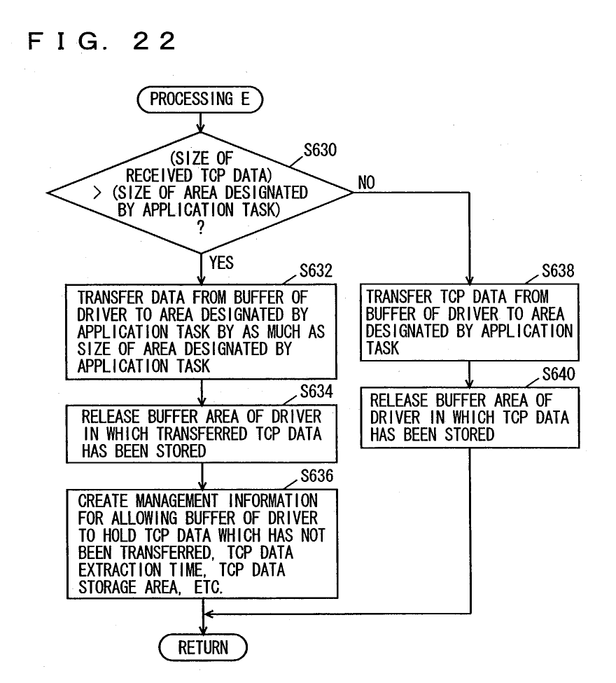

Referring to FIG. 22, processing E in S600 will be described. In S630, CPU 120 determines whether or not the size of the received TCP data is larger than the size of the buffer area designated by the application task. If the size of the received TCP data is larger than the size of the buffer area designated by the application task (“YES” in S630), the processing proceeds to S632. If not (“NO” in S630), the processing proceeds to S638.

In S632, CPU 120 transfers the data from the buffer of the driver to the buffer area designated by the application task by as much as the size of the buffer area designated by the application task. In S634, CPU 120 releases the buffer area of the driver in which the transferred TCP data has been stored. In S636, CPU 120 creates management information for allowing the buffer of the driver to hold the TCP data which has not been transferred. This management information includes TCP data extraction time, a TCP data storage area and the like. After the processing in S636, the processing proceeds to S118.

In S638, CPU 120 transfers the TCP data from the buffer of the driver to the buffer area designated by the application task. In S640, CPU 120 releases the buffer area of the driver in which the TCP data has been stored. Thereafter, the processing proceeds to S118.

The operation of the PDA which includes the communication device according to this embodiment based on the above-mentioned structure and the flowcharts will be described.

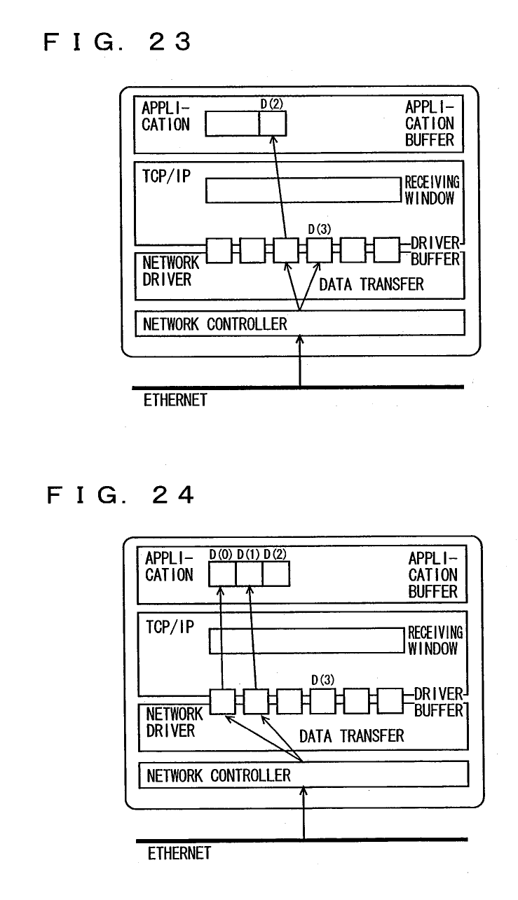

FIGS. 23 to 26 show procedures for the transfer between the buffers in the PDA including the communication device according to this embodiment. In this embodiment, when a receiving request is issued from application task 126 of the PDA, no data is held in the receiving window and the buffer of the driver. FIGS. 23 to 26 show processings if a receiving request from application task 126 is set in a wait state until data is received and an Ethernet frame including TCP/IP packets is received from the Ethernet. It is assumed herein that the transmission end communication device transmits the Ethernet frame including data D(0), D(1), D(2) and D(3) in this order and that the receiving end PDA receives the Ethernet frame including data D(2), D(3), D(1) and D(0) in this order.

In this embodiment, as in the case of the fifth embodiment, the extracted TCP segment data is transferred not to the receiving window but to the buffer designated by the application task from the buffer of the driver. It is noted, however, that only the data which can be contained in the buffer designated by the application task is transferred and the other data exceeding the preset number is held in the buffer of the driver. It is assumed herein that time for which the data is held in the buffer of the driver is not longer than preset time. Further, the data is held in the buffer of the driver, management information for managing data extraction time, memory arrangement address information on the data, the size of the data and the like is created (in S116).

The data held in the buffer of the driver is transferred to the buffer designated by application task 126 if a receiving request is issued from application task 126 by the preset time. If a receiving request is not issued from application task 126 by the preset time, the data is transferred from the buffer of the driver to the receiving window.

As shown in FIG. 23, if an Ethernet frame including data D(2) is received, data D(2) is extracted as in the case of the fifth embodiment. Thereafter, since data D(2) can be contained in the buffer designated by application task 126 (“NO” in S630), data D(2) is transferred to the buffer designated by application task 126. If an Ethernet frame including data D(3) is received, data D(3) is extracted. However, data D(3) cannot be contained in the buffer designated by application task 126 (“YES” in S630). Due to this, data D(3) is held in the buffer of the driver. At this moment, information for managing time T(3) at which data D(3) was extracted, memory arrangement address information on data D(3), the size of data D(3) and the like is created (in S636). At this moment, since data transmitted before data D(2) is missing, a receiving request issued from application task 126 is continuously set in a wait state.

FIG. 24 shows a case where Ethernet frames including data D(1) and D(0) are received thereafter. Since extracted data D(0) and D(1) can be contained in the buffer designated by application task 126 (“NO” in S630), data D(0) and D(1) is transferred to the buffer designated by application task 126 (in S632). By this time, continuous data D(0) to D(2) can be received, so that the wait state of the receiving request issued from application task 126 is released.

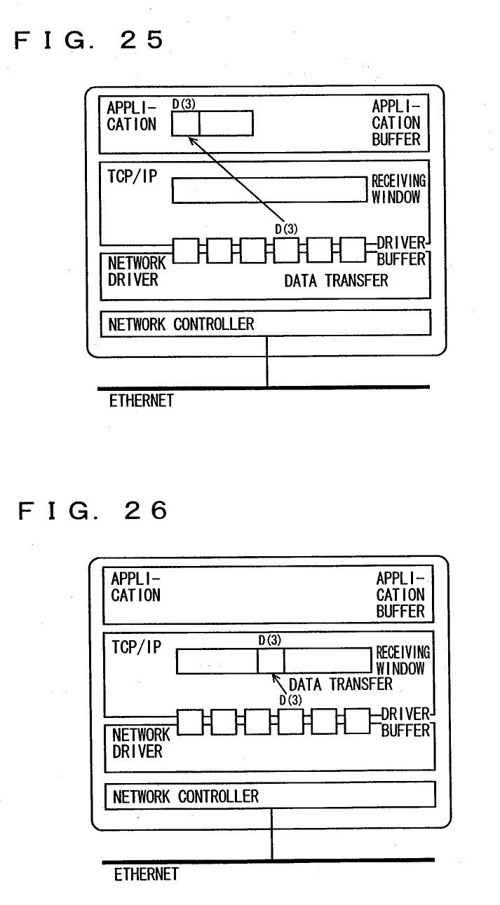

FIG. 25 shows a case where time for which data D(3) is held in the buffer of the driver is not longer than preset time and a receiving request is reissued from application task 126. When a receiving request is issued from application task 126, the management information corresponding to data D(3) held in the buffer of the driver is referred to and data D(3) is transferred from the buffer of the driver to the buffer designated by application task 126. The management information corresponding to transferred data D(3) is erased.

FIG. 25 shows a case where the size of data D(3) held in the buffer of the driver is not larger than the size of the buffer designated by application task 126. If the size of data D(3) held in the buffer of the driver exceeds the size of the buffer designated by application task 126, data D(3) held in the buffer of the driver is transferred by as much as a size equal to the size of the buffer designated by application task 126. The remaining data which has not been transferred, is continuously held in the buffer of the driver and management information is updated to correspond to data D(3).

FIG. 26 shows a case where a receiving request is not reissued from application task 126 by the time for which data D(3) is held in the buffer of the driver exceeds the preset time. If no receiving request is issued from application task 126 at certain time T, the management information corresponding to data D(3) stored in the buffer of the driver is referred to and a period dT(3) from time T until time T(3) for which data D(3) is held is calculated. If period dT(3) exceeds a preset period, data D(3) is transferred from the buffer of the driver to the receiving window. At this moment, the management information corresponding to data D(3) is erased.

As can be seen, in the PDA including the communication device according to this embodiment, data D(0) to D(2) is transferred from the buffer of the driver to the buffer designated by the application task without going through the receiving window. By doing so, it is possible to decrease the number of times of data transfer, compared with the conventional art. In addition, if a receiving request is issued from the application task by the preset time, data D(3) is transferred from the buffer of the driver to the buffer designated by the application task without going through the receiving window, as well. Due to this, compared with the conventional art, it is possible to decrease the number of times of data transfer. Furthermore, if a receiving request is not issued from the application task by the preset time, data D(3) held in the buffer of the driver is transferred to the receiving window. Therefore, the probability that the buffer of the driver is occupied by data D(3) is decreased compared with a case where no time limitation is given. Due to this, even if an Ethernet which does not include TCP/IP packets is received or a plurality of application tasks are executed on the PDA and the respective application tasks communicate with the other device, then it is possible to decrease the probability that the Ethernet frame received by the network controller cannot be transferred to the buffer of the driver.

Seventh Embodiment

A PDA which includes a communication device according to the seventh embodiment will be described. The hardware configuration of the PDA according to this embodiment is the same as that of the PDA according to the first embodiment. The detailed description thereof will not be, therefore, repeatedly given herein.

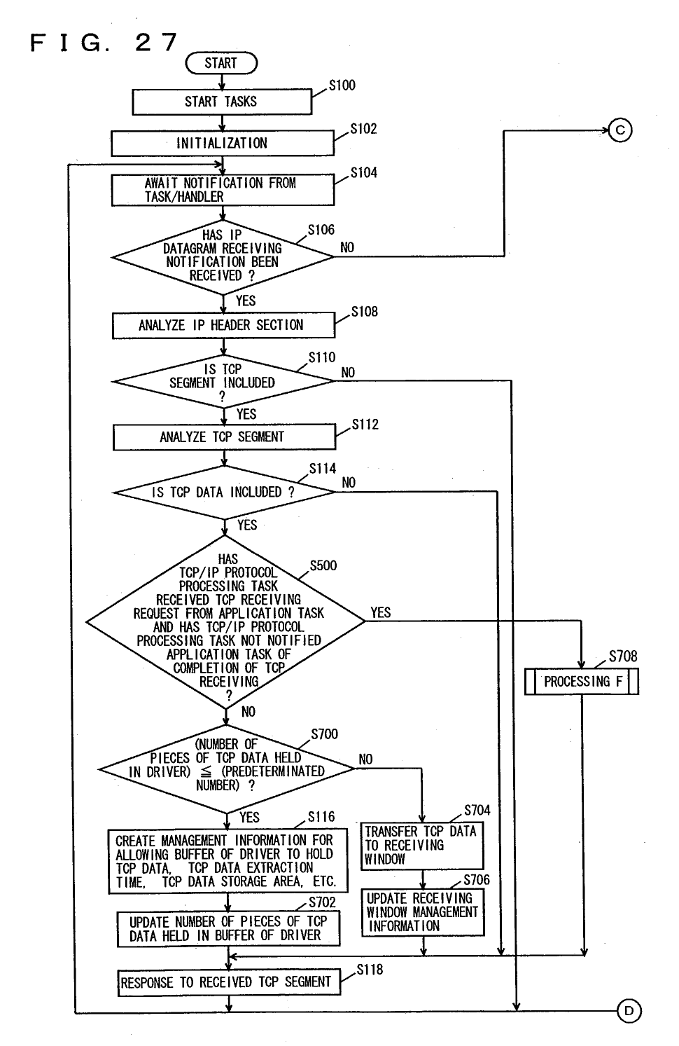

Referring to FIG. 27, a program executed by the PDA including the communication device according to this embodiment has the following control structure. In the flowchart shown in FIG. 27, the same processings as those in the flowchart shown in FIG. 21 are denoted by the same step numbers, respectively. Processings therefor are the same, as well. These processings will not be, therefore, repeatedly described herein.

In S500, CPU 120 determines whether or not TCP/IP protocol processing task 124 has received a TCP receiving request from application task 126 and has not notified application task 126 of the completion of TCP receiving. If TCP/IP protocol processing task 124 has received a TCP receiving request from application task and has not notified application task 126 of the completion of TCP receiving (“YES” in S500), the processing proceeds to S708. If not (“NO” in S500), the processing proceeds to S700.

In S700, CPU 120 determines whether or not the number of pieces of TCP data held in the driver is not greater than a preset number. If the number of pieces of TCP data held in the driver is not greater than a preset number (“YES” in S700), the processing proceeds to S116.. If not (“NO” in S700), the processing proceeds to S704.

In S702, CPU 120 updates the number of pieces of TCP data held in the buffer of the driver. Thereafter, the processing proceeds to S118 and then to S104.

In S704, CPU 120 transfers the TCP data to the receiving window. In S706, CPU 120 updates receiving window management data. Thereafter, the processing proceeds to S118 and then to S104.

In S708, CPU 120 performs a processing F.

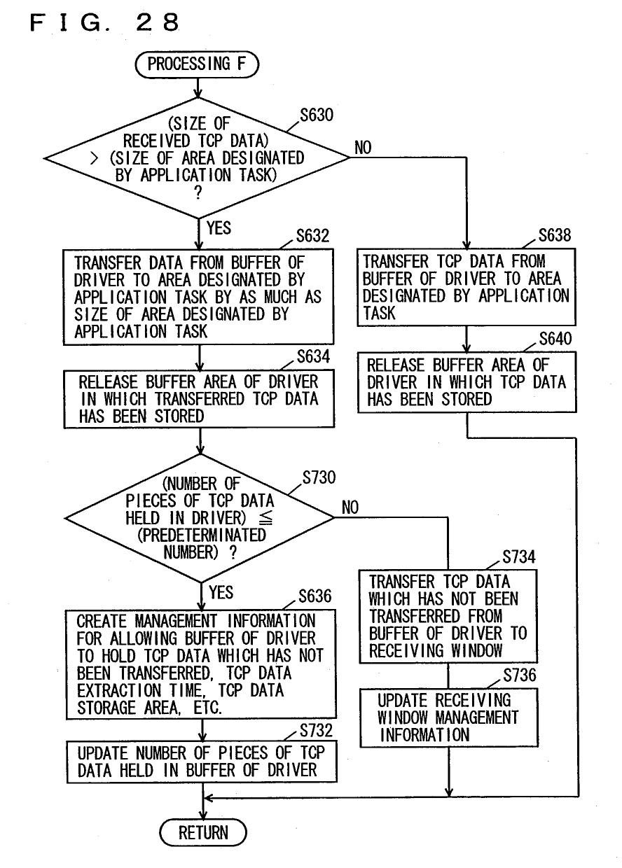

Referring to FIG. 28, processing F in S708 will be described. In the flowchart shown in FIG. 28, the same processings as those in the flowchart shown in FIG. 22 are denoted by the same step numbers, respectively. Processings therefor are the same, as well. They will not be, therefore, repeatedly described herein in detail.

In S730, CPU 120 determines whether or not the number of pieces of TCP data held in the driver is not greater than the preset number. If the number of pieces of TCP data held in the driver is not greater than the preset number (“YES” in S730), the processing proceeds to S636. If not (“NO” in S730), the processing proceeds to S734.

In S732, CPU 120 updates the number of pieces of TCP data corresponding to the buffer of the driver. Thereafter, the processing proceeds to S118.

In S734, CPU 120 transfers the TCP data which has not been transferred, from the buffer of the driver to the receiving window. In S736, CPU 120 updates the receiving window management information. Thereafter, the processing proceeds to S118.

The operation of the PDA which includes the communication device according to this embodiment based on the above-mentioned structure and the flowchart will be described. In this embodiment, as in the case of the sixth embodiment, the extracted TCP segment data is not transferred to the receiving window but to the buffer designated by the application task from the buffer of the driver. It is noted, however, that only the data which can be contained in the buffer designated by the application task is transferred and the other data is held in the buffer of the driver.

The data is held in the buffer of the driver under the condition that the time for which the data is held in the buffer of the driver is within the preset time as described in the sixth embodiment and under the condition, unlike the sixth embodiment, that the number of pieces of data held in the buffer of the driver is within a preset number (“YES” in S700 and “YES” in S730). Since the operation of holding the data in the buffer of the driver based on the preset number is the same as that of the second embodiment, it will not be repeatedly described herein in detail.

As can be seen, according to the PDA including the communication device in this embodiment, in addition to the operation in the sixth embodiment, the number of pieces of data held in the buffer of the driver is limited to not greater than the preset number. Due to this, it is possible to secure the empty areas of the buffer of the driver by as much as the preset number of pieces of data. Therefore, even if an Ethernet frame which does not include TCP/IP packets is received or even if a plurality of application tasks are executed on the PDA and the respective application tasks communicate with other devices, it is possible to decrease the probability that the Ethernet frame received by the Ethernet controller cannot be transferred to the buffer of the driver.

Eighth Embodiment

A PDA which includes a communication device according to the eighth embodiment will be described. The hardware configuration of the PDA according to this embodiment is the same as that of the PDA according to the first embodiment. The detailed description thereof will not be, therefore, repeatedly given herein.

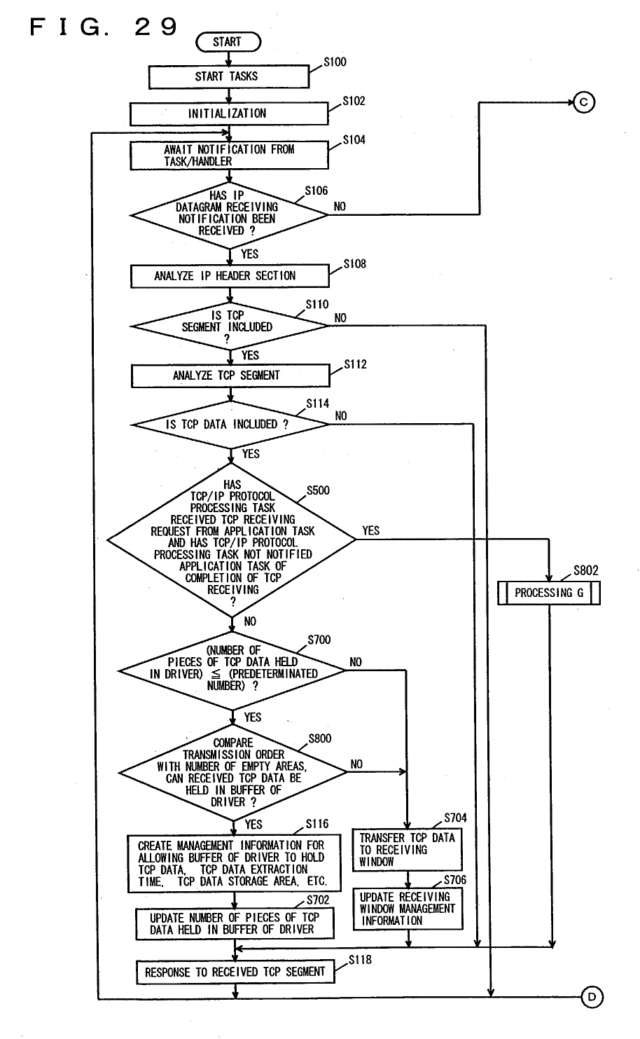

Referring to FIG. 29, a program executed by the PDA including the communication device according to this embodiment has the following control structure. In the flowchart shown in FIG. 29, the same processings as those in the flowchart shown in FIG. 27 are denoted by the same step numbers, respectively. Processings therefore are the same, as well. These processings will not be, therefore, repeatedly described herein.

In S500, CPU 120 determines whether or not TCP/IP protocol processing task 124 has received a TCP receiving request from application task 126 and has not notified application task 126 of the completion of TCP receiving. If TCP/IP protocol processing task 124 has received a TCP receiving request from application task 126 and has not notified application task 126 of the completion of TCP receiving (“YES” in S500), the processing proceeds to S802. If not (“NO” in S500), the processing proceeds to S700.

In S800, CPU 120 compares a transmission order with the number of empty areas and determines whether or not the received TCP data can be held in the buffer of the driver. If the comparison between the transmission order and the number of empty areas shows that the TCP data can be held in the buffer of the driver (“YES” in S800), the processing proceeds to S116. If not (“NO” in S800), the processing proceeds to S704.

In S802, CPU 120 performs a processing G.

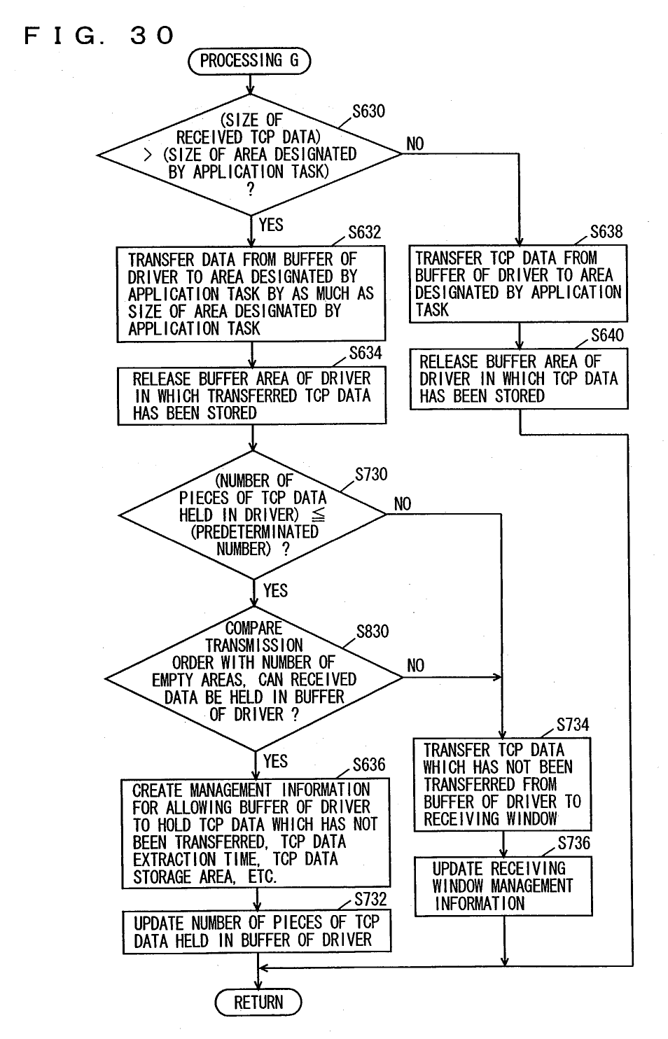

Referring to FIG. 30, processing G in S802 will be described. In the flowchart shown in FIG. 30, the same processing as those in the flowchart shown in FIG. 28 are denoted by the same step numbers, respectively. Processings therefore are the same, as well. These processing will not be, therefore, repeatedly described herein in detail.

In S830, CPU 120 compares a transmission order with the number of empty areas and determines whether or not the received data can be held in the buffer of the driver. If the comparison between the transmission order and the number of empty areas shows that the received data can be held in the buffer of the driver (“YES” in S830), the processing proceeds to S636. If not (“NO” in S830), the processing proceeds to S734. After the processings in S636 and S732, the processing proceeds to S118 and then returns to S104.

After the processings in S734 and S736, the processing proceeds to S118 and then to S104.

The operation of the PDA which includes the communication device according to this embodiment based on the above-mentioned structure and the flowcharts will be described. In this embodiment, as in the case of the seventh embodiment, the extracted TCP segment data is not transferred to the receiving window but to the buffer designated by the application task 126 from the buffer of the driver. It is noted, however, that only the data which can be contained in the buffer designated by the application task 126 is transferred and the other data is held in the buffer of the driver. Here, the data which is held in the buffer of the driver is limited to the data which satisfies the two conditions, as described in the seventh embodiment, that the time for which the data is held in the buffer of the driver is within the preset time and that the number of pieces of data held in the buffer of the driver is within a preset number. In addition to the two conditions, the data which is held in the buffer of the driver is limited to the data which satisfies the condition, as in the case of the third embodiment, that data is in the order of transmission and within a range of the preset number (“YES” in S700 and “YES” in S800). The other data is transferred from the buffer of the driver to the receiving window.

Since the conditions that only the data which is in the order of transmission from the transmission end device and within the preset number is held in the buffer of the driver are the same as those in the third embodiment, they will not be repeatedly described herein in detail.

As can be seen, according to the PDA including the communication device according to this embodiment, by limiting the number of pieces of data held in the buffer of the driver based on the order of transmission, it is possible to decrease the probability that the data is transferred to the receiving window after the preset time, compared with a case of limiting the number of pieces of data held in the buffer of the driver based on the order of receiving. As a result, it is possible to decrease the number of pieces of data transferred from the buffer of the driver to the receiving window and to decrease power consumption required for TCP protocol processings.

Ninth Embodiment

A PDA which includes a communication device according to the ninth embodiment will be described. The hardware configuration of the PDA according to this embodiment is the same as that of the PDA according to the first embodiment. The detailed description thereof will not be, therefore, repeatedly given herein. Further, a program executed by the PDA including the communication device according to this embodiment has a control structure in which it is determined whether or not received data is to be held in the buffer of the driver based on a preset data size. Since the processings for determining whether or not the received data is to be held in the buffer of the driver based on the data size are the same as those in the fourth embodiment, they will not be repeatedly described herein in detail.

In the seventh and eighth embodiments, it is determined whether or not the received data is to be held in the buffer of the driver based on the number of pieces of data. In this embodiment, by contrast, it is determined whether or not the received data is to be held in the buffer of the driver based on the data size. By doing so, if the size of the received data is relatively small, it is possible to increase the number of empty areas of the buffer of the driver, compared with a case where the size of the received data is relatively large. As a result, compared with the PDA in the seventh and eighth embodiments, it is possible to further decrease the number of times of transferring the received data to the receiving window.

Tenth Embodiment

A PDA which includes a communication device according to the tenth embodiment will be described. In the first to ninth embodiments, the preset time, the preset number and the preset data size are constant values. In the communication device according to this embodiment, by contrast, these values can be set by the application task. The hardware configuration of the PDA according to this embodiment is the same as that of the PDA according to the first embodiment. The detailed description thereof will not be, therefore, repeatedly given herein.

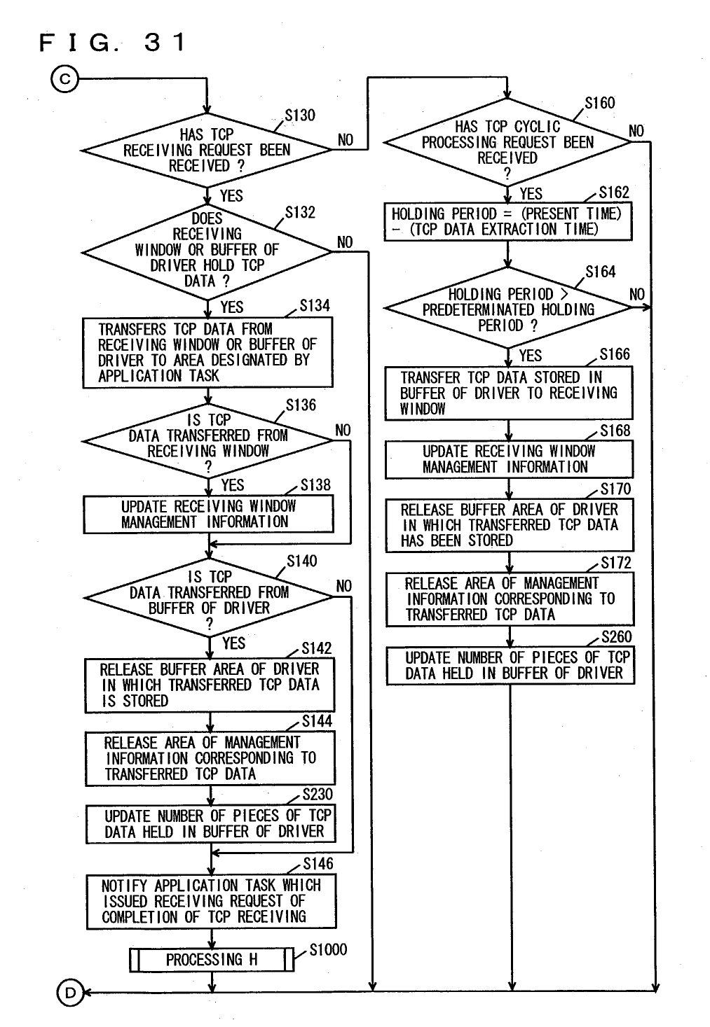

Referring to FIG. 31, a program executed by the PDA including the communication device according to this embodiment has the following control structure. In the flowchart shown in FIG. 31, the same processings as those in the flowchart shown in FIG. 10 are denoted by the same step numbers, respectively. Processings therefor are the same, as well. These processings will not be, therefore, repeatedly described herein in detail.

After the processing in S146, CPU 120 performs a processing H in S1000 and the processing then proceeds to S104.

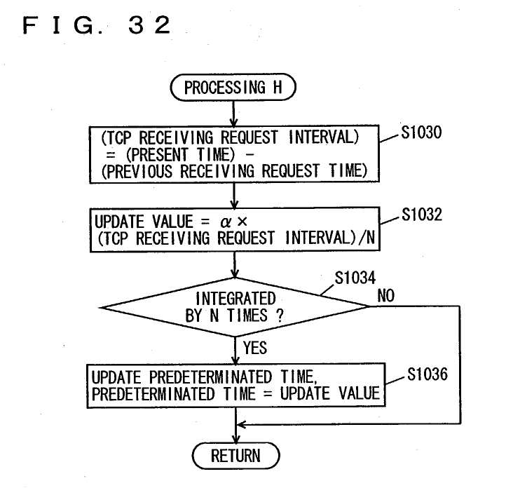

Referring to FIG. 32, processing H in S1000 will be described. In S1030, CPU 120 calculates a TCP receiving request interval as TCP receiving request interval=(present time)−(previous receiving request time). In S1032, CPU 120 performs an arithmetic operation of holding time update value=a×(TCP receiving request interval)/N. In S1034, if N is integrated by a preset number of times (“YES” in S1034), the processing proceeds to S1036. If not (“NO” in S1034), the processing proceeds to S104.

In S1036, CPU 120 updates preset time. The preset time is assumed as the update value calculated in S1032.

The operation of the PDA including the communication device according to this embodiment based on the above-mentioned structure and flowcharts will be described.

The PDA calculates an average of values obtained by multiplying the TCP receiving request interval by a coefficient ax in accordance with the intervals at which receiving requests are issued from application task 126 (in S1032). If the processing has been performed by a preset sample number (N) (“YES” in S1034), the preset time is updated to the calculated average (in S1036).

As can be seen, according to the PDA including the communication device according to this embodiment, the application task can dynamically change the preset time in accordance with the content of the processing of the application task. It is thereby possible to further decrease the number of times of transferring data from the buffer of the driver to the receiving window.

In this embodiment, description has been given while assuming that the preset time is updated. However, the present invention is not limited thereto. The preset number of pieces of data and the preset data size may be also subjected to arithmetic operations by the application task so as to change the conditions for transferring the data from the buffer of the driver to the receiving window.

Eleventh Embodiment

A PDA which includes a communication device according to the eleventh embodiment will be described. The hardware configuration of the PDA according to this embodiment is the same as that of the PDA according to the first embodiment. The detailed description thereof will not be, therefore, repeatedly given herein.

The PDA including the communication device according to this embodiment can change the preset time, the preset number of pieces of data and the preset data size of the PDA according to the first to ninth embodiments, depending on the state of the network.

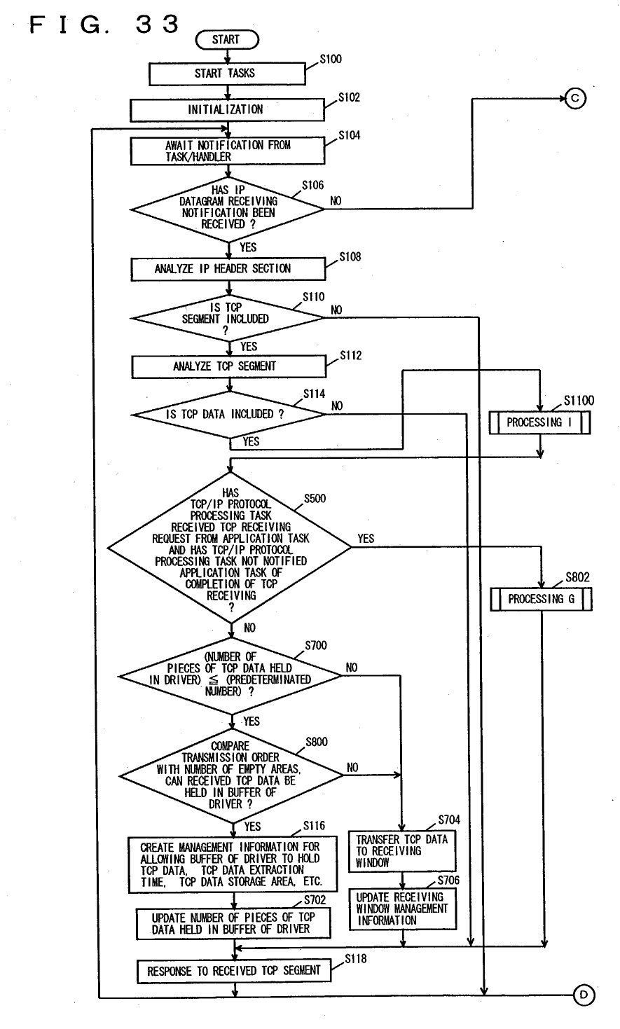

Referring to FIG. 33, a program executed by the PDA including the communication device according to this embodiment has the following control structure. In the flowchart shown in FIG. 33, the same processings as those in the flowchart shown in FIG. 29 are denoted by the same step numbers, respectively. Processings therefore are the same, as well. These processings will not be, therefore, repeatedly described herein in detail.

If the result of the analysis of the TCP segment shows that TCP data is included, CPU 120 performs a processing I in S1100.

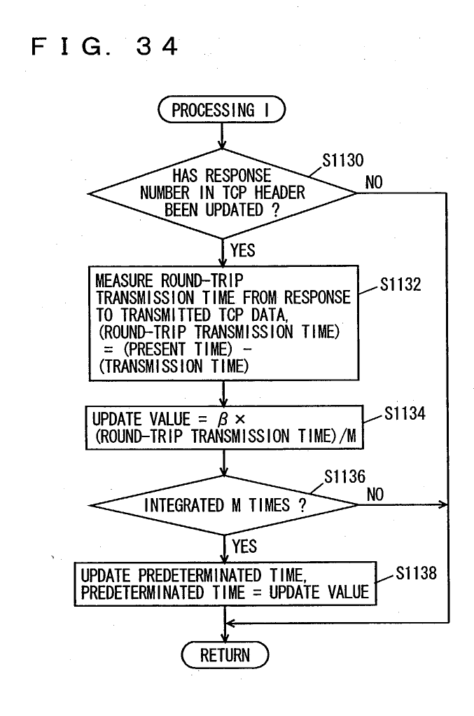

Referring to FIG. 34, processing I in S1100 will be described. In S1130, CPU 120 determines whether or not a response number in a TCP header has been updated. The response number in the TCP header indicates that there is a response to transmitted TCP data. If the response number in a TCP header has been updated (“YES” in S1130), the processing proceeds to S1132. If not (“NO” in S1130), the processing proceeds to S500.

In S1132, CPU 120 measures round-trip transmission time from the response to the transmitted TCP data. Here, the round-trip transmission time is measured as round-trip transmission time=(present time)−(transmission time). In S1134, CPU 120 performs an arithmetic operation of update value=β×(round-trip transmission time)/M. In S1136, CPU 120 determines whether or not M is integrated by a preset number of times. If M is integrated by a preset number of times (“YES” in S1136), the processing proceeds to S1138. If not (“NO” in S1136), the processing proceeds to S500.

In S1138, CPU 120 updates the preset time. Here, the preset time is set at the update value calculated in S1134. Thereafter, the processing proceeds to S500,

The operation of the PDA which includes the communication device according to this embodiment based on the above-mentioned structure and the flowcharts will be described.

The PDA regularly measures data transmission time for transmitting data from the transmission end to the receiving end (in S1132). An average of values obtained by multiplying the measured transmission time by a coefficient β is calculated as the update value (in S1134). If the transmission time is relatively long, the interval at which the data is transmitted from the transmission end to the receiving end is long. Therefore, the preset time is set long (in S1138). If the transmission time becomes short depending on the state of the network, the interval at which the data is transmitted from the transmission end to the receiving end is short. Therefore, the preset time is set short (in S1138).

As mentioned so far, the PDA which includes the communication device according to this embodiment can change the setting of time for which the data is held in the buffer of the driver depending on the state of the network (transmission time on the network). It is thereby possible to appropriately change conditions for transferring the data from the buffer of the driver to the receiving window depending on the communication state of the network and to decrease the number of times of transferring the data from the driver to the receiving window depending on the state of the network.

In this embodiment, description has been given while assuming that the condition changed depending on the state of the network is the preset time. However, the present invention is not limited thereto. The preset number of pieces of data and the preset data size may be changed according to the state of the network (data transmission time).

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A communication device comprising:
a network control circuit controlling transmission and reception of a data item for a network;
a first storage circuit connected to said network control circuit, and temporarily storing the received data item;
a second storage circuit connected to said first storage circuit, and storing data item; and
a control circuit controlling said data items stored in said first storage circuit and said second storage circuit to be transferred to a predetermined buffer, wherein
said control circuit includes:
a first transfer control circuit controlling said first storage circuit to transfer said data item stored in said first storage circuit to said buffer in response to a request to store data in said buffer, when the request is issued before preset time passes since said data item has been stored in said first storage circuit; and
a second transfer control circuit controlling said second storage circuit to transfer said data item stored in said first storage circuit to said second storage circuit when the preset time passes since said data item has been stored in said first storage circuit, and to transfer said data item stored in said second storage circuit to said buffer in response to the request to store data in said buffer.

2. The communication device according to claim 1, wherein
said first transfer control circuit includes a circuit transferring said data item stored in said first storage circuit to said buffer in response to the request issued before the preset time passes since said data item has been stored in said first storage circuit, until a preset number of data items have been stored in said first storage circuit, and
said second transfer control circuit includes a circuit transferring said data item stored in said first storage circuit to said second storage circuit if one of a condition that preset time passes since said data item has been stored in said first storage circuit and a condition that the preset number of data items have been stored in said first storage circuit is satisfied.

3. The communication device according to claim 2, wherein
said first transfer control circuit includes a circuit transferring said data item stored in said first storage circuit to said buffer in response to the request issued before the preset time passes since said data item has been stored in said first storage circuit, until the preset number of data items have been stored in said first storage circuit in accordance with an order of transmission of said data items to said first storage circuit.

4. The communication device according to claim 1, wherein
said first transfer control circuit includes a circuit transferring said data item stored in said first storage circuit to said buffer in response to the request issued before preset time passes since said data item has been stored in said first storage circuit, until a preset capacity of data items have been stored in said first storage circuit, and
said second transfer control circuit includes a circuit transferring said data item stored in said first storage circuit to said second storage circuit if one of a condition that the preset time passes since said data item has been stored in said first storage circuit and a condition that the preset capacity of data items have been stored in said first storage circuit is satisfied.

5. The communication device according to claim 4, wherein
said first transfer control circuit includes a circuit transferring said data item stored in said first storage circuit to said buffer in response to the request issued before the preset time passes since said data item has been stored in said first storage circuit, until the preset capacity of the data items have been stored in said first storage circuit in accordance with an order of transmission of said data items to said first storage circuit.

6. The communication device according to claim 1, wherein
said control circuit further includes a third transfer control circuit controlling said first storage circuit to transfer said data item stored in said first storage circuit to said buffer in response to the request, when the request is issued before said data item is stored in said first storage circuit.

7. The communication device according to claim 6, wherein
the request includes information indicating a transfer capacity of the data items transferred from said first storage circuit to said buffer, and
said third control circuit includes a circuit controlling said first storage circuit to transfer the data items not larger than said transfer capacity out of said data items stored in said first storage circuit to said buffer in response to the request issued before said data item is stored in said first storage unit, and to store the data items exceeding said transfer capacity in said first storage circuit.

8. The communication device according to claim 1, wherein
said preset time is set based on a signal from a transmitting end of the request to store data in said buffer.

9. The communication device according to claim 8, wherein
said preset time is set based on a frequency of the request transmitted from the transmission end.

10. The communication device according to claim 2, wherein
said preset number is set based on a signal from a transmission end of the request to store data in said buffer.

11. The communication device according to claim 4, wherein
said preset capacity is set based on a signal from a transmission end of the request to store data in said buffer.

12. The communication device according to claim 1, wherein
said preset time is set based on a communication state of said network.

13. The communication device according to claim 12, wherein
said preset time is set based on transmission time required for transmitting the data to said communication device on said network.

14. The communication device according to claim 2, wherein
said preset number is set based on a communication state of said network.

15. The communication device according to claim 4, wherein
said preset capacity is set based on a communication state of said network.
